(19) United States
(12) Patent Application Publication
(10) Pub. No.: US 2009/0148254 A1
(43) Pub. Date: Jun. 11, 2009

(54) FLANGE HEADED SCREW

(76) Inventors: Daniel Carrillo,, SR., Palmdale, CA (US); Hector Carrillo, Palmdale, CA (US)

Correspondence Address: CHRISTIE, PARKER & HALE, LLP, PO BOX 7068, PASADENA, CA, 91109-7068, US

(21) Appl. No.: 11/953,508

(22) Filed: Dec. 10, 2007

(51) Int. Cl. F16B 35/04; F16B 23/00

(52) U.S. Cl. 411/404; 411/424; 411/403

(57) ABSTRACT

A flange headed screw. The flanged headed screw has a threaded shank portion with a shank diameter, a distal tip, and a proximal end. A stop flange with a diameter that is larger than the shank diameter of the threaded shank located at the proximal end of the threaded shank portion. A projection portion extends from the stop flange, and the projection portion has a diameter smaller than the diameter of the stop flange. A driving head with a driving engagement located at a proximal end of the projection portion.

### FIELD OF THE INVENTION

The present invention relates to the field of builders hardware and more particularly to a novel flange headed screw for driving into a construction material so that a portion of the screw outwardly projects from the surface of the construction material even after the flange headed screw is completely screwed into the construction material.

### BACKGROUND OF THE INVENTION

In the past, it has been the conventional practice to employ a single head nail in a concrete form, on posts, or the like, in order to mark a particular location. By employing a single headed nail, removal is difficult since the head of the nail is normally sunk into or is flush with the construction material, such as a stake or wood post, in which the single-headed nail is hammered. In some instances, the nail is intentionally not completely hammered into the construction form since many nail locations need to be tied together and a single head nail may have been hammered too tight or even counter-sunk which may be required on such occasions.

In other instances, a double-headed nail may eliminate some of the above problems because a portion of the nail is extended or projected out of the construction form or other material, such as a post. However, a problem still exists when employing concrete forms which take many different shapes and designs and employ many kinds of applications, such as a cantilevered form. Double-headed nails work excellently for this type of application to prepare the forms for concrete. However, removal of the double-headed nail from poured concrete has proven difficult. When removing the forms with a hammer or pry bar, substantial pressure is placed on the forms which can break the edge of the freshly poured cement. In this event, it is extremely difficult to repair and can cause a less than acceptable finished product which, in turn, adds time and expense to a project. Similar considerations apply to use of a single or double headed nail in cases where a user wishes to avoid using a claw hammer or pry bar to pry out the nail since doing so can mar the surface of the material and/or cause the material to shift or move.

In response to these problems with nails, some builders of concrete forms and other structures have taken to using conventional single headed screws, such as floor screws, to screw together, instead of nail together, concrete form material. While this can partially alleviate the above identified problem since this can eliminate or reduce the need for pry bars, a new problem arises. Frequently, when pouring and finishing the concrete, concrete splashes outside of the form and conceals the position of the screws and fills the drive surface of the screw head (e.g., the grooves of the Philips head), which makes engagement of the screw head with a screw driver difficult. Workers must then waste valuable time locating all the screws holding the concrete form together and then clean out the drive surfaces of the screw heads.

There accordingly exists a long-standing need for practical solutions to the above described problems.

### SUMMARY OF THE INVENTION

Accordingly, the above problems and difficulties are solved by the present invention which provides an elongated double-headed or flanged screw having an elongated threaded shank terminating at its distal end with a pointed tip. The head of the screw includes a first or stop flange which separates a smooth shank from the threaded shank and terminates at its end opposite to its pointed tip with a second flange which comprises a driving head. The driving head may include a recess having a variety of different geometric shapes in order to receive specially shaped or configured driving tools. Also, the peripheral edge of the driving head may include a variety of shapes, such as a hexagon configuration, in order to receive a driving tool of that shape. The first flange prevents the double-headed screw from penetrating into the concrete or wood beyond the length of the threaded shank. The area between the first and second flanges on the double head outwardly projects from the construction material and is smooth surfaced so that string, cord or the like, may be tied thereon.

Therefore, it is among the primary objects of the present invention to provide a novel flanged headed screw which includes a defined external portion which outwardly projects from the stake, concrete or construction foundation into which the flange headed screw is installed for subsequent location purposes and easy engagement with a driver tool.

Another object of the present invention is to provide a novel flange headed screw which includes an outwardly cantilevered or projection portion to which string, cord or the like may be readily attached and detached therefrom.

Still another object is to provide a novel flange headed screw having an elongated threaded shaft terminating at one end in a pointed tip and at its other end in a driving head which limits penetration of the screw into a concrete form, wooden stake or the like.

Another object of the invention is to provide a strong, flange headed screw for construction form installation that does not require excessive pressure for removal, and which a double-headed screw can be installed or backed away without moving the construction form that the screw is installed in.

A further object of the invention is to provide a double-headed screw having a drive head which will accept any one of a variety of different shaped or geometric configured driving tools so that the rotary action of the tool will drive the threaded shank of the screw into building material or cause removal thereof.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings in which:

FIG. 1 is a front perspective view of a building installation incorporating the use of an exemplary embodiment of a double flange headed screw of the invention;

FIG. 2 is a greatly enlarged perspective view of the flange headed screw used in the installation shown in FIG. 1;

FIG. 3 is a longitudinal cross sectional view of the double-headed screw shown in FIG. 2 as taken in the direction of arrows 3-3 thereof;

FIGS. 4-7 inclusive illustrate a variety of driving heads used on the double headed screw having recesses of different geometric configurations for accepting a variety of driving tools;

FIG. 8 is an isometric view of another exemplary embodiment of a flange headed screw of the invention;

FIG. 9 is a diagrammatic side view showing the flange headed screw of FIG. 8; and

FIG. 10 is a top view of the flange headed screw of FIG. 8.

### DETAILED DESCRIPTION OF THE INVENTION

Referring to FIG. 1, the novel double-headed screw incorporating the present invention is illustrated in the general direction of arrow 10 and is employed for installation in a construction material, such as a concrete or wooden post 11a. A second or alternate double-headed screw is illustrated by numeral 13 and is installed in a second post 11b which is in fixed, spaced-apart relationship with respect to post 11a and separated by slats 12. A cord 14 is installed between the two double-flanged or headed screws by winding or tying the opposite ends of the cord respectively to portions 17 on each of the respective screws. An enlarged flange 16 on each screw prevents each of the respective screws from penetrating further into the construction material when driven by a driving tool (not shown) engageable with a driving head 18 carried on the extreme terminating end of the screw. As can be seen in broken lines, numeral 15 represents the threaded length of shank that penetrates the construction material and is stopped from further penetration by engagement of the limit or stop flange 16 with the construction material. The driving head 18 is configured with a recess in the form of an “X” so that a Phillips type driving instrument can be engaged therewith. As will be described further below, other configurations may be employed in the driving head to accept a variety of different shaped driving tools.

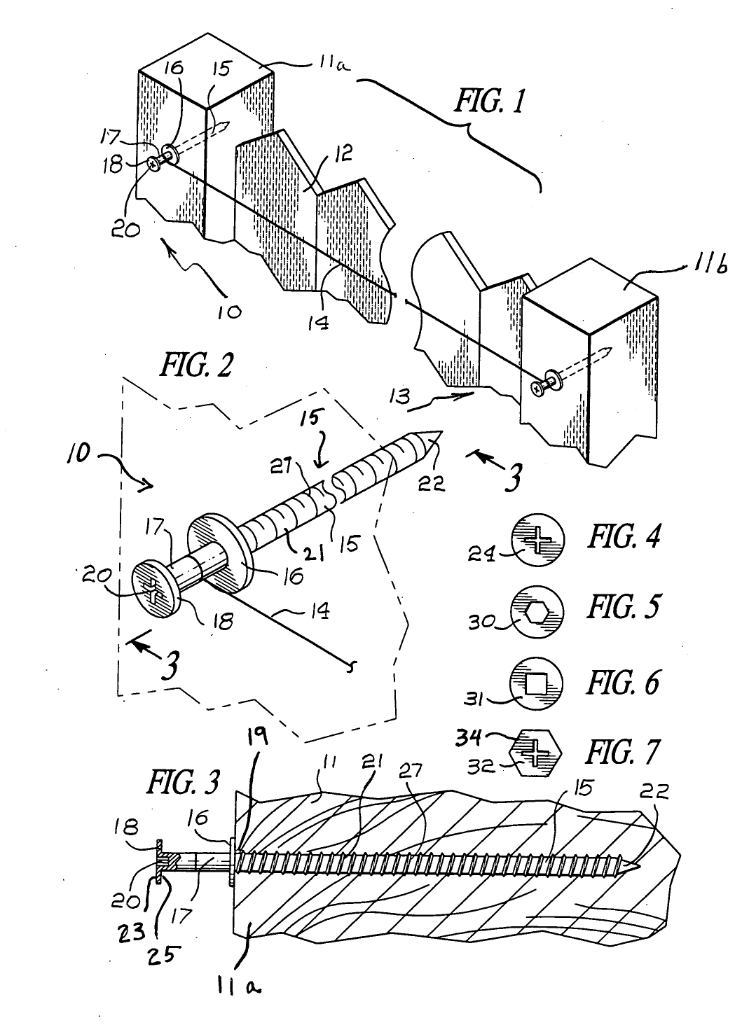

Referring now to FIG. 2, it can be seen that the exemplary flanged head or double-headed screw 10 includes an elongated shank 15 having an outer exterior surface 21 which has threads 27 of any particular pitch or angle desired by the user. The distal end of the threaded shank terminates in a pointed tip 22 while the opposite end terminates in a driving head 18. The “X” configuration recess 20 forms a Phillips head and will receive a mating configured driving tool (not shown) for installation or removal. A preferably smooth surface (unthreaded) projection portion 17 is disposed between the opposing surfaces of the driving head or flange 18 and the limit or stop flange 16. The stop flange 16 preferably has a flat tip facing surface 19. The projection portion 17 and driving head 18 of the threaded screw 10 is exposed for location of the screw 10 in construction material and/or for tying on of a cord 14 for support of other types of construction uses. Although shown with a Phillips type driving recess 20, other driving engagements can be provided, some examples of which are as described below.

Referring now to FIG. 3, it can be seen that the threads are indicated by numeral 27 and form a spiral from the stop flange 16 to the pointed tip 22. If desired, the whole length of the shank 15 need not be threaded, and for example, the portion of the shank near the stop flange 16 can be smooth (not shown), and the length of the shank and its dimensions can be modified as desired. Also, the smooth projection portion 17 is exposed since the stop flange 16 limits penetration of the threaded portion into the construction material. The stop flange 16 preferably has a flat tip facing surface 19 which seats on the material 11a. The driving head 18 is preferably of a generally flat design with a flat top surface 23 and a flat underside 25. This provides adequate strength to the driving head 18 and when the screw 10 is used for holding a cord, as shown in FIG. 2, will help retain the cord 14 on the smooth projection portion 17 without sliding off of the driving head 18.

Referring now to FIGS. 4-7 inclusive, a variety of driving heads are illustrated so that a variety of driving tools may be employed. FIG. 4 discloses an “X” shape uses for driving the screw with a Phillips tool, while FIG. 5 discloses a recess configured with a hexagon and is indicated by driving head 30, and can be driven, for example, with a Allen type driving tool. FIG. 6 illustrates driving head 31 with a square recess therein, while FIG. 7 illustrates that the driving head periphery may be shaped to a particular configuration to accept still another type of driving tool. The driving head 32 may include any one of the previously described recess configurations, as well as a shaped external peripheral edge, shown here as having a hexagonal outer perimeter 34.

In view of the foregoing, it can be seen that the double-headed or double flanged screw of the present invention will penetrate construction material, such as wood, concrete or the like, for the full length of the shank 15 aided by the spiral threads 27 and the pointed tip 22. However, penetration is arrested when the stop flange 16 reaches the surface of the construction material. At this time, the smooth projection portion 17 is visibly available for locating the screw and will not as likely have the recess 20 of its driving head 18 filled with concrete. Furthermore, the smooth projection portion 17 will be available for attachment of any other construction material, such as a line, string or cord. Again, the double headed screw can be provided with a wide variety of driving heads to accept a driving tool for installing or removing the double-headed screw.

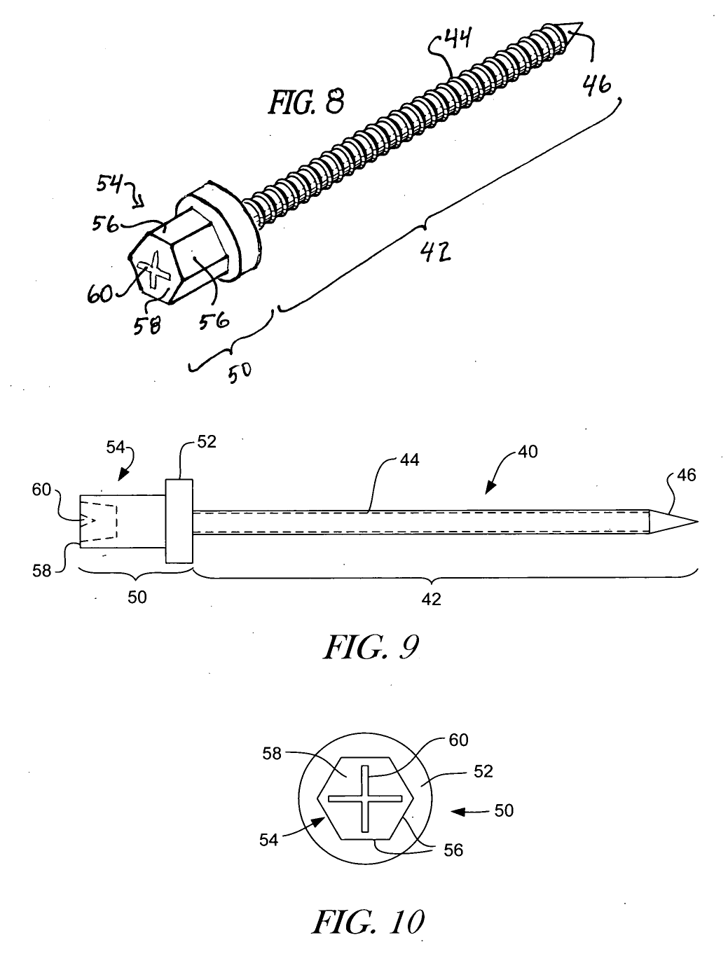

FIG. 8 is a isometric view and FIG. 9 is a diagrammatic side view of another exemplary embodiment of a flange headed screw 40 of the invention, which is similar to the exemplary embodiment 10 shown in FIGS. 2 and 3, and has at distal region 42 with an at least partially threaded shank portion 44 with a tip 46, a proximal portion 50 with a stop flange 52 and an extension 54 that has an engagement cross section, such as a hexagonal cross-section that is perpendicular to the axis of the screw 40. The stop flange 52 has planar sides 56 of the extension 54 to provide a surface for turning the screw 40. At a terminal end 58 of the extension 54 can be located an optional driving engagement 60, such as a Phillips head recess. This provides two ways to drive the screw 40. The stop flange 52 should have a diameter larger than that of the extension 54, large enough to provide good seating of the screw with the material the screw is driven into.

FIG. 10 is a top view showing of the flange headed screw of FIG. 8 and shown its proximal portion 50 with its stop flange 52, extension 54 with planar sides 56. At a terminal end 58 of the extension 54 is shown the optional driving engagement 60, in the form of a Phillips head recess. A screw driving tool, such as a long throat hex socket wrench will fit over the engagement 54 and turned, with the stop 52 preventing contact of the screw driving tool with the material into which the screw 40 is engaged.

While particular embodiments of the present invention have been shown and described, it will be obvious to those skilled in the art that changes and modifications may be made without departing from this invention in its broader aspects and, therefore, the aim in the appended claims is to cover all such changes and modifications as fall within the true spirit and scope of this invention.

What is claimed is:

1. A flange headed screw, comprising:
a threaded shank portion having a shank diameter, a distal tip, and a proximal end;
a stop flange with a diameter that is larger than the shank diameter of the threaded shank located at the proximal end of the threaded shank portion;
a projection portion that extends from the stop flange, the projection portion having a diameter smaller than the diameter of the stop flange; and
a driving head with a driving engagement at a proximal end of the unthreaded projection portion.

2. The flange headed screw of claim 1, wherein the driving head has a generally flat bottom surface and has a diameter larger than the diameter of the projection portion.

3. The flange headed screw of claim 1, wherein the driving head has a generally flat top and bottom surface and has a diameter larger than the diameter of the projection portion.

4. The flange headed screw of claim 1, wherein the stop flange has a generally flat bottom surface.

5. The flange headed screw of claim 1, wherein the driving engagement of the driving head comprises a recess in the driving head.

6. The flange headed screw of claim 1, wherein the projection portion is unthreaded.

7. The flange headed screw of claim 1, wherein the projection portion comprises the driving head with a plurality of generally flat sides.

8. The flange headed screw of claim 7, wherein the projection portion has a hexagonal cross-section.

9. The flange headed screw of claim 7, wherein the driving engagement further comprises a driving recesses at a proximal end of projection portion.

10. The flange headed screw of claim 1, wherein the threaded shank portion is threaded along its entire length.

11. A flange headed screw, comprising:
a threaded shank portion having a shank diameter, a distal tip, and a proximal end;
a stop flange with a generally flat bottom surface and with diameter that is larger than the shank diameter of the threaded shank located at the proximal end of the threaded shank portion;
a projection portion that extends from the stop flange, the projection portion having a diameter smaller than the diameter of the stop flange; and
a driving head with a generally flat bottom surface and has a diameter larger than the diameter of the projection portion, and with a driving engagement at a proximal end of the projection portion comprising a recess in the driving head.

12. The flange headed screw of claim 11, wherein the projection portion is unthreaded.

13. A flange headed screw, comprising:
an at least partially threaded shank portion having a shank diameter, a distal tip, and a proximal end;
a stop flange with a diameter that is larger than the shank diameter of the threaded shank located at the proximal end of the threaded shank portion;
a projection portion that extends from the stop flange, the projection portion having a plurality of generally flat sides.

14. The flange headed screw of claim 13, wherein the projection portion has a diameter smaller than the diameter of the stop flange.

15. The flange headed screw of claim 13, wherein the projection portion has a hexagonal cross-section.

16. The flange headed screw of claim 13, wherein a driving recess is located at a proximal end of the projection portion.
